(19) United States
(12) Patent Application Publication
(10) Pub. No.: US 2016/0147838 A1
(43) Pub. Date: May 26, 2016

(54) RECEIVING NODE, DATA MANAGEMENT SYSTEM, DATA MANAGEMENT METHOD AND STRAGE MEDIUM

(71) Applicant: NEC CORPORATION, Minato-ku, Tokyo (JP)

(72) Inventors: Junpei KAMIMURA, Tokyo (JP); Dai KOBAYASHI, Tokyo (JP); Satoshi YAMAKAWA, Tokyo (JP)

(21) Appl. No.: 14/895,559

(22) PCT Filed: Apr. 30, 2014
(86) PCT No.: PCT/JP2014/002377

§ 371 Date: Dec. 3, 2015

(30) Foreign Application Priority Data
Jun. 14, 2013 (JP) 2013-125550

(51) Int. Cl. G06F 17/30

(52) U.S. Cl. CPC G06F 17/30507; G06F 17/30289; G06F 17/30312

(57) ABSTRACT

Disclosed is a technique that satisfies both the dispersion performance of the data storage locations and the access efficiency in data acquisition, even when handling a wide variety of sensor data. A receiving node determines, upon receipt of a data storage request or a data acquisition request, a data server in which data is to be stored. The receiving node includes key generation unit which generates a new key using a specified data key and a masked time-of-day acquired by applying a mask to a specified time-of-day, and destination node calculation unit which determines the data server in which the data is to be stored, using the new key generated by the key generation unit.

This application is a National Stage Entry of PCT/JP2014/002377 filed on Apr. 30, 2014 which claims priority from Japanese Patent Application 2013-125550 filed on Jun. 14, 2013, the contents of all of which are incorporated herein by reference, in their entirety.

### TECHNICAL FIELD

The present disclosure relates to a data management system for managing data in a dispersed manner, a receiving node employed for the management, a data management method and a storage medium.

### BACKGROUND ART

Realization of a system is expected that collects data generated time after time from scores of thousand, or several hundred thousand smart phones and sensors existing in the real world, and creates values through analysis of such data. Such a system is generally called a cyber-physical system (CPS).

To construct the CPS, a storage system that allows the collected data to be efficiently accumulated and looked up is required.

In the storage system, the data is dispersed to a plurality of servers or storage devices (HDD), in order to handle an enormous amount of data and allow the data to be quickly accessed.

For example, a data writing method called striping is employed, by which the data is divided and written in a plurality of hard disks at the same time. By the striping, the region of the hard disk is divided into blocks of a certain size called stripe size, and the access to the region is made simultaneously in parallel with respect to each of the disks. When the size of the data to be access at a time is larger than the stripe size, the access to the plurality of hard disks can be made simultaneously in parallel, and therefore the data access can be made at a higher speed.

In addition, an algorithm called consistent hashing is known, which is used to allocate the data to a plurality of servers in a dispersed manner. By the consistent hashing, hash spaces are located on a ring, and a server in which the data is to be allocated is determined on the basis of the following positions on the ring. One is the position of a hash value (specific hash value) calculated using as a key the identifier of the server in which the data is to be allocated, and the other is the position of a hash value calculated using as a key the identifier of the data to be allocated. The range of each specific hash value, in other words the hash value to be handled by each server, is defined according to the position on the ring of the specific hash value associated with each server. To obtain the allocation destination of the data, the hash value calculated using the identifier of the data as a key and the specific hash value associated with the server may be compared. Then for example the specific hash value located at the same position on the ring as the hash value of the data, or closest thereto in the clockwise direction, may be identified. Although the mentioned example refers to the case where the hash values are allocated to the specific hash values in the in the clockwise direction, the hash values may be allocated in different patterns. An advantage of employing the consistent hashing is that an impact of addition or deletion of the server can be suppressed.

PTL 1 discloses an example of an information storage and retrieval device that employs the consistent hashing.

PTL 2 discloses a method of extracting a data set associated with individual events on the basis of approximation on a time axis, so as to process, on the real time basis, successively generated time series data such as observation data from a sensor net.

### CITATION LIST

### Patent Literature

PTL 1: Unexamined Japanese Patent Application Kokai Publication No. 2011-258115

PTL 2: Unexamined Japanese Patent Application Kokai Publication No. 2009-009304

### SUMMARY OF INVENTION

### Technical Problem

In general, when the data is to be allocated to a plurality of servers in a dispersed manner, it is required that a uniform amount of data be allocated to each of the servers. This is because the load is unable to be efficiently dispersed when the data retention amount per server is uneven.

To uniformly allocate the data allocated to the servers, the storage location of the data may be determined such that the server in which the data is to be stored is changed each time a predetermined data amount is stored, for example like the striping. With such a method, however, the data storage location varies depending on the data flow volume, and hence when data generated by a given sensor at a given time-of-day is to be acquired, an additional system is required to find where the data is stored. For example, a mechanism that retains the data identifier and the storage location in association with each other is required.

A possible solution to the above is allocating the data storage location using the identifier of the sensor as the key of the data, so as to establish a certain level of association between the data and the storage location of the data. Such a method allows all the data having the same identifier to be allocated to the same server, thereby enabling the server to which the data has been allocated to be easily identified from the sensor identifier, when the data is to be acquired.

With the mentioned method, however, the data retention amount per server may become uneven when the sensors each generate a different amount of data, which disables efficient dispersion of the load. In addition, the data from the same sensor concentrates at a specific server.

Therefore, when a large amount of data is to be acquired from a given sensor, the quick access, which can be achieved by making access in parallel from a plurality of servers, is unable to be performed.

Another solution would be dispersing the data utilizing a combination of the identifier of the sensor and the time-of-day as a key. In this case, a different key is generated with respect to each piece of sensor data, and hence the data is dispersed each time. However, although the data retention amount per server can be levelled off by this method, access performance is degraded when a certain mass of data around a specific time-of-day from a given sensor identifier is to be acquired. Since a different key is generated when the time-of-day is different despite the sensor identifier being the same, the data may be stored in a different server. Accordingly, even when a certain mass of data around a specific time-of-day from a given sensor identifier is to be acquired, it is necessary to identify the storage location with respect to each time-of-day when making access to the server. Therefore, the access to the server has to be made an increased number of times.

Further, in the case of data access using the hash, data acquisition by range specification may become even more inefficient. This is because the data acquisition request has to be made using a key in which the sensor identifier is combined to all the times-of-day included in a specified range, when the data is to be acquired by range specification of the time-of-day. In this case, the number of times of server access is increased in proportion to the number of times-of-day.

The sensor data is composed of, for example, the sensor identifier, the time-of-day, and the value measured by the sensor. Since the sensor generates the measured values time after time, the data having the same sensor identifier but representing a different time-of-day and measured value is stored in the dispersed storage system. In addition, the data having a different sensor identifier is stored in the dispersed storage system. Further, the amount of the data generated by each of the sensors may be uneven depending on various factors such as the type of the sensor, the position of the sensor, and the time zone of measurement.

Thus, regarding the dispersed storage system for storing a wide variety of sensor data generated in the CPS time after time, it is difficult to satisfy both the dispersion performance of the data storage locations and the access efficiency in data acquisition, at the same time.

Here, the method according to PTL 2 is a data extraction method applicable to the case of processing the time series data on the real time basis, and only serves to sequentially cut and divide partial data strings based on the approximation on the time axis. PTL 2 involves no consideration at all on processing the time-of-day information so as to uniformly store the sensor data unevenly generated by different sensors in a plurality of servers. PTL 2 involves no consideration either, on securing the efficiency that can be achieved by parallelization, even when a large amount of data is to be acquired.

The present disclosure has been accomplished to solve the foregoing problems, and provides a data management system, a receiving node, a data management method, and a data management program. The present disclosure enables the dispersion performance of the data storage locations and the access efficiency in data acquisition to be satisfied at the same time. This can be realized even when handling a wide variety of sensor data generated time after time in different amounts depending on the sensor type and time-of-day.

### Solution to Problem

A receiving node of the present invention is characterized by determining, upon receipt of a data storage request or a data acquisition request, a data server in which data is to be stored. The receiving node includes circuitry configured to:

generate a new key using a specified data key and a masked time-of-day acquired by applying a mask to a specified time-of-day; and

determine the data server in which the data is to be stored, using the new key generated by the key generation.

A data management system of the present invention is characterized by including:

one or more data servers including data storage unit which stores data; and

one or more receiving nodes.

Each of the receiving nodes includes:

key generation unit which generates a new key using a specified data key and a masked time-of-day acquired by applying a mask to a specified time-of-day; and

destination node calculation unit which identifies the data server in which the data is to be stored, using the new key generated by the key generation unit.

A data management method of the present invention includes;

by a receiving node,

generating a new key using a specified data key and a masked time-of-day acquired by applying a mask to a specified time-of-day, upon receipt of a data storage request or a data acquisition request; and

identifying the data server in which the data is to be stored, using the new key generated by the key generation.

A non-transitory computer-readable storage medium storing a data management program of the present invention is characterized by being configured to cause a computer to perform:

a key generation process including generating a new key using a specified data key and a masked time-of-day acquired by applying a mask to a specified time-of-day, upon receipt of a data storage request or a data acquisition request; and

a destination node calculation process including identifying the data server in which the data is to be stored, using the new key generated in the key generation process.

### Advantageous Effects of Invention

With the foregoing configuration, the present disclosure provides an eminent effect of satisfying the dispersion performance of the data storage locations and the access efficiency in data acquisition at the same time. This can be realized even when handling a wide variety of sensor data generated time after time in different amounts depending on the sensor type and time-of-day.

### BRIEF DESCRIPTION OF DRAWINGS

FIG. 1 is a block diagram showing a configuration of a data management system according to a first exemplary embodiment;

FIG. 2 is a block diagram showing a functional configuration of a receiving node 10;

FIG. 3 is a flowchart showing an outline of the operation of the receiving node 10;

FIG. 4 is a flowchart showing a process of determining a storage location when storing data;

FIG. 5 is a flowchart showing a process of generating a mask when storing data;

FIG. 6 is a flowchart showing a process of generating a mask when acquiring data by direct specification;

FIG. 7 is a flowchart showing a process of determining a storage location when acquiring data by range specification;

FIG. 8 is a flowchart showing a process of generating a mask when acquiring data by range specification;

FIG. 9 is a block diagram showing a configuration of a data management system according to a second exemplary embodiment;

FIG. 10 is a block diagram showing a functional configuration of a receiving node 10 according to the second exemplary embodiment;

FIG. 11 is a block diagram showing minimum necessary components of the receiving node according to the present disclosure; and

FIG. 12 is a block diagram showing minimum necessary components of the data management system according to the present disclosure.

### DESCRIPTION OF EMBODIMENTS

### First Exemplary Embodiment

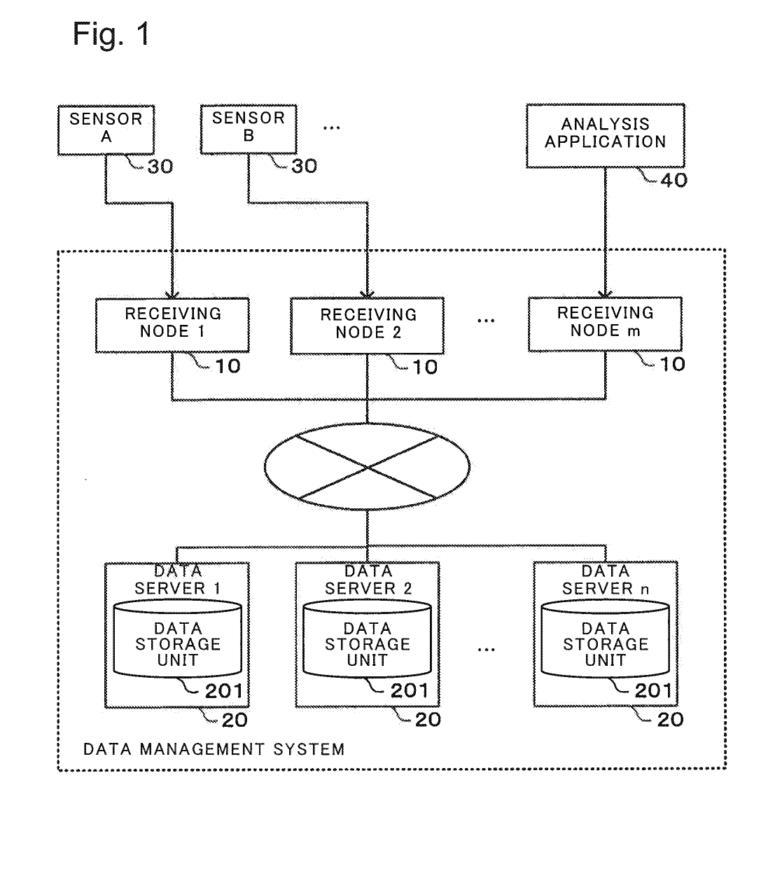

Hereafter, exemplary embodiments of the present disclosure will be described with reference to the drawings. FIG. 1 is a block diagram showing a configuration of a data management system according to a first exemplary embodiment. The data management system shown in FIG. 1 includes one or more receiving nodes 10 and one or more data servers 20.

At least each of the receiving nodes 10 is connected to each of the data servers 20 via a communication network.

As is apparent from the indication of “receiving node 1, receiving node 2, . . . , receiving node m” and “data server 1, data server 2, . . . , data server n” in FIG. 1, m pieces of receiving nodes 10 and n pieces of data servers 20 are provided in the system. However, it suffices that one or more each of receiving nodes 10 and data servers 20 are provided.

Although two sensors 30 are illustrated in FIG. 1 as examples of nodes that make a data storage request to the system (hereinafter, storage request node), the storage request node is not limited to the sensor. In addition, the number of storage request nodes is not specifically limited. Although FIG. 1 illustrates as if the sensors 30 and the receiving nodes 10 are associated on a one-to-one basis, the mode of association between the sensors (storage request nodes) and the receiving nodes is not specifically limited. For example, the sensors and the receiving nodes may be associated on any of an N-to-one basis, a one-to-N basis, and N-to-N basis. In other words, a single receiving node may be allocated to a plurality of sensors, a plurality of receiving nodes may be allocated to a single sensor, or a plurality of receiving nodes may be allocated to a plurality of sensors. Further, the counterpart may be fixed, or selected each time.

Although an analysis application 40 is illustrated in FIG. 1 as an example of a node that makes a data acquisition request to the system (hereinafter, acquisition request node), the acquisition request node is not limited to the analysis application. The number of acquisition request nodes is not specifically limited. The mode of association between the acquisition request node and the receiving node is not specifically limited, either.

The data server 20 includes a data storage unit 201 in which data is stored, and stores the data transmitted from the receiving node 10 in the data storage unit 201. The data server 20 also retrieves data stored in the data storage unit 201 in accordance with a request from the receiving node 10, and transmits the data to the receiving node 10 which is the requesting party. The data server 20 may be, for example, a storage server including a hard disk drive, a non-volatile memory, a volatile memory, a solid state drive (SSD), and a communication interface.

The receiving node 10 performs various processings to allow the data server 20 to properly disperse the data. The receiving node 10 may be, for example, an information processing device including a central processing unit (CPU) that operates according to a program, storage devices, and a communication interface. The storage devices may include a hard disk drive, a non-volatile memory, a volatile memory, and an SSD, and the communication interface enables communication with the data server 20, the storage request node, and the acquisition request node. The communication interface for communication with the data server 20, the storage request node, and the acquisition request node may be shared by a plurality of receiving nodes 10 or provided for each receiving node 10.

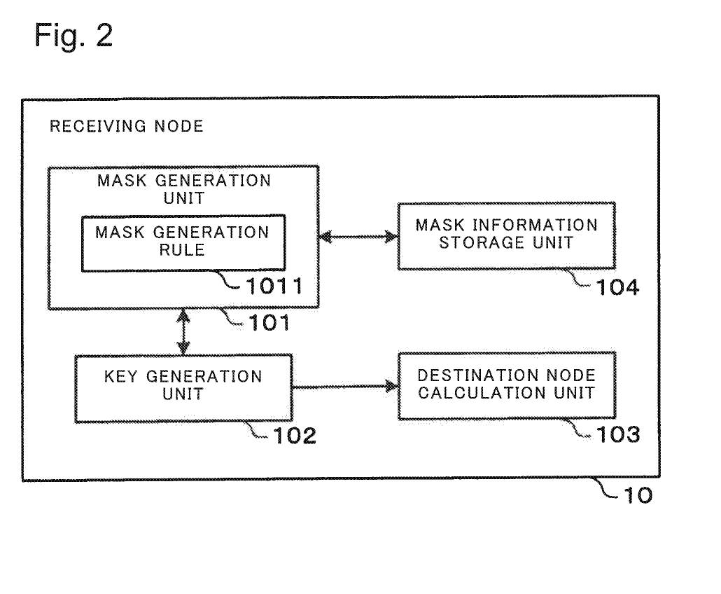

FIG. 2 is a block diagram showing a functional configuration of the receiving node 10. As shown in FIG. 2, the receiving node 10 may include a mask generation unit 101, a key generation unit 102, a destination-node calculation unit 103, and a mask information storage unit 104.

The mask generation unit 101 generates, upon receipt of a key and time-of-day of data, a mask to be applied to the time-of-day inputted, according to a mask generation rule 1011 to be subsequently described. Then the mask generation unit 101 provides the mask to the key generation unit 102. The term “mask generation” also includes identifying a mask out of masks stored, and acquiring the identified mask.

The provided by the mask generation unit 101 may be, for example, a bit mask, but without limitation thereto. In the present disclosure, the mask applied to the time-of-day may provide a specific method or measure to process or convert the information so as to at least lower data granularity, compared with the state before the mask is applied. Here, the data granularity refers to a degree indicating how many patterns can be expressed by the whole data. The mask may process information, for example, such that the times-of-day included in a specific time range are given the same value. As a specific example, the information may be processed so as to lower the granularity of the time-of-day, for example omitting a time equal to or shorter than 30 seconds. Here, the mask is not limited to the one that performs such fraction processing (rounding) of the time-of-day. For example, the mask may convert the time-of-day information so that the times-of-day included in the same time zone of the same day of the same month are given the same value. In addition, it is not mandatory that the converted value expresses the time-of-day. For example, the times-of-day on the time series may be classified into a plurality of groups, and the time-of-day information may be converted so as to allow the time-of-day in each group to indicate a representative value of the group. In this case, a conversion module for converting the inputted time-of-day to the representative value of the group in which the time-of-day is included may be provided as the mask. When the number of groups is fewer than the number of patterns of the time-of-day, the data granularity can be lowered. Here, it is preferable that a data aggregate presumed to be often acquired in a lump is located in the same group. For example, specific times-of-day close to each other may be located in the same group.

The data format of the inputted time-of-day is not specifically limited. The data may be, for example, numerical data expressing YMDHMS in predetermined digits, or numerical data expressing the number of seconds from a reference time point. Without limitation to such numerical data, character data expressing YMDHMS in a predetermined format may be adopted. The character data may be adopted provided that the data granularity is lowered by applying the mask. In this exemplary embodiment, it will be assumed that a time-of-day of data generation or a time-of-day of data reception is inputted as the time-of-day.

The mask generation rule 1011 is information that stipulates which type of mask is to be generated, on the basis of the inputted information. In the mask generation rule 1011, for example information on a key value of the data and information on the mask to be generated may be associated with each other. Examples of the information on the key value include information indicating the key value itself and the range thereof. Examples of the information on the mask include information on the mask itself and the identifier for identifying the mask prepared in advance, and information indicating the conversion rule of the time-of-day. Instead of directly specifying the information to be inputted, such as the key value and time-of-day of the data, information on the system configuration such as the number of nodes, or information of the generation source of data identified by the key value of the inputted data may be employed. Further, information indicating the status of the system at the inputted time-of-day may be employed. Examples of the information of the generation source include the type of the sensor and the position of the sensor, and examples of the information of the status of the system include the data flow volume and the load on the system. Here, the system includes a measurement device that measures the data flow volume and the load on the system when necessary. Hereinafter, the information associated with the information regarding the mask to be generated and registered in the mask generation rule 1011 may be collectively referred to as “mask generation condition”. The mask generation condition may be composed of a combination of two or more factors.

The mask generation unit 101 is capable of generating, in accordance with the mask generation rule 1011 defined as above, different masks depending on the key value of the data, or on the time zone in which the data has been generated. In addition, the mask generation unit 101 is capable of generating different masks, in accordance with the mask generation rule 1011, depending on the system configuration, the type or position of the sensor, or on the data flow volume and the load on the system. Without limitation to the mentioned examples, the mask generation condition and the mask information may be registered in the mask generation rule 1011, so as to allow the storage location node to be switched according to the data generation pattern and the data acquisition pattern.

When the mask generation unit 101 generates different masks on the basis of dynamic information in accordance with the mask generation rule 1011 when storing the data, the mask generation unit 101 stores the generated mask information in the mask information storage unit 104, together with the information inputted at that point. Here, the dynamic information refers to such information the content of which may vary while the system is in operation, and is hence unidentifiable from the original key and the time-of-day, which are the query contained in the request. Then the mask generation unit 101 acquires, when the mask to be generated differs depending on the dynamic information, the corresponding mask out of the mask information stored in the mask information storage unit 104 when acquiring the data, and provides such mask. More specifically, the mask generation unit 101 searches the key and time-of-day of the data stored in the mask information storage unit 104 using the key and time-of-day of the inputted data. Then the mask generation unit 101 provides, in the case where the information of the mask generated in the past on the basis of the information of the same content is registered, the mask same as the one generated in the past on the basis of that information.

The key generation unit 102 applies, upon receipt of the key and time-of-day of the data, the mask provided by the mask generation unit 101 to the inputted time-of-day thereby acquiring a masked time-of-day. Then the key generation unit 102 combines the acquired masked time-of-day with the key of the data, thereby generating a new key. Hereinafter, in order to distinguish between the key generated by the key generation unit 102 and the key of the inputted data, the key of the inputted data may be referred to as “original key”, and the key generated by the key generation unit 102 may be referred to as “new key”.

The destination-node calculation unit 103 performs a predetermined process on the basis of the new key generated by the key generation unit 102, to determine the data server 20 in which the data is to be stored. Hereinafter, the data server 20 in which the data is to be stored may be referred to as destination node. The destination-node calculation unit 103 may input, for example the new key generated by the key generation unit 102 in a predetermined hash function, to thereby identify the destination node by consistent hashing, on the basis of the obtained hash value.

The mask information storage unit 104 records the mask information in accordance with the request from the mask generation unit 101, and provides the mask information stored therein. Here, the mask information storage unit 104 may be omitted in the case where the mask generation rule 1011 does not include the rule to generate different masks depending on the dynamic information.

In this exemplary embodiment, the mask generation unit 101, the key generation unit 102, and the destination-node calculation unit 103 are realized, for example, by a CPU that operates in accordance with a program. The mask information storage unit 104 is realized, for example, by a storage device.

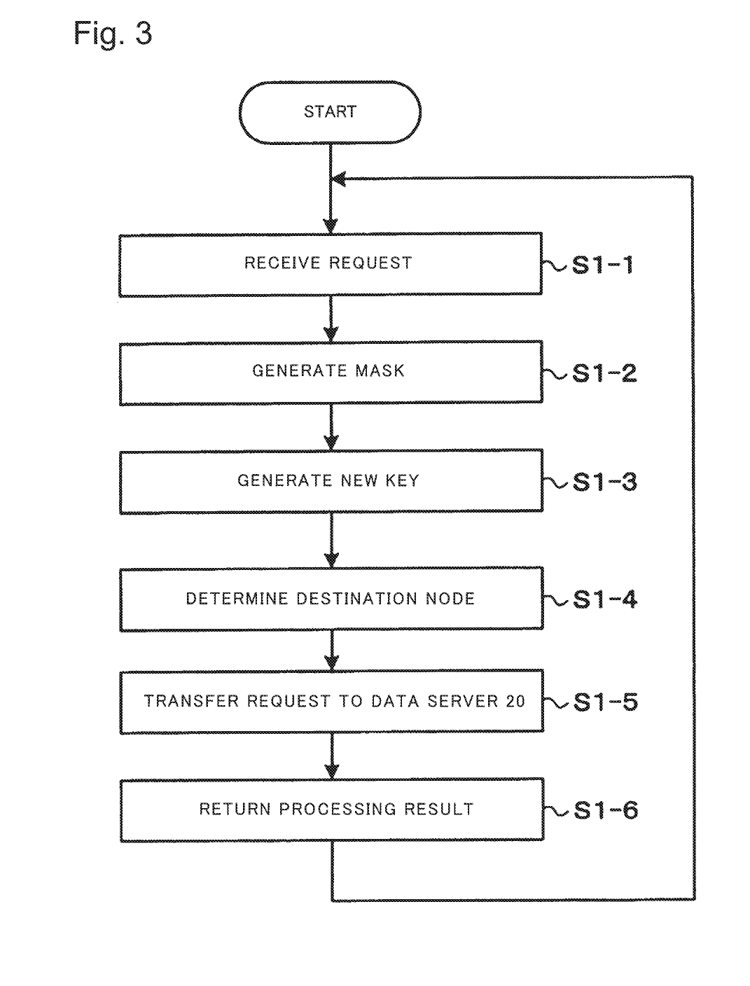

Hereunder, an operation performed in this exemplary embodiment will be described. FIG. 3 is a flowchart showing an outline of the operation of the receiving node 10 of the data management system according to this exemplary embodiment. As shown in FIG. 3, first the receiving node 10 receives from outside a data storage request or a data acquisition request with specification of a key (original key) and time-of-day of the data (step S1-1). Then the mask generation unit 101 generate a mask to be applied to the time-of-day (step S1-2).

The key generation unit 102 then applies the mask generated by the mask generation unit 101 to the specified time-of-day, and generates a new key by combining the obtained masked time-of-day and the original key of the specified data (step S1-3).

Then the destination-node calculation unit 103 performs a predetermined process using the new key generated by the key generation unit 102, thereby identifying a destination node (step S1-4). The destination-node calculation unit 103 then transfers the received request to the identified destination node (step S1-5).

When the request from the receiving node 10 is a data storage request, the data server 20 stores the data accompanying the request in the data storage unit 201 together with the information of the original key and time-of-day of the data accompanying the request, and returns the processing result. When the request from the receiving node 10 is a data acquisition request, the data server 20 retrieves the requested data from the data storage unit 201 on the basis of the information of the original key and time-of-day of the data accompanying the request, and returns the processing result including the retrieved data.

Upon receipt of the processing result from the data server 20 to which the request was sent, the receiving node 10 returns the received processing result to the node that made the request (step S1-6).

The operation of the receiving node 10 will now be described in further details, with a specific example. Hereunder, the process of determining the storage location of data generated by three sensors will be described, with respect to the case of storing the data and the case of acquiring the data.

It will be assumed that the sensors are each given an identifier of Sensor A, Sensor B, and Sensor C, and data is dispersed utilizing these identifiers as original key. It will also be assumed that the following mask generation rule 1011 is prepared for each of the sensors.

### [Mask Generation Rule]

For Sensor A, a mask that always omits a period of time equal to or shorter than one minute of the time-of-day will be applied, as a fixed rule.
For Sensor B, rules that vary depending on the time zone are applied. In the morning during which the data amount is presumed to be smaller, a mask that omits a period of time equal to or shorter than 30 minutes of the time-of-day will be applied. In the afternoon during which the data amount is presumed to be larger, a mask that omits a period of time equal to or shorter than one minute of the time-of-day will be applied.
For Sensor C, rules that vary depending on the data flow volume (number of pieces of data arriving per unit time) are applied. When the data flow volume is less than 10 pieces/minute, a mask that omits a period of time equal to or shorter than 10 minutes of the time-of-day will be applied. When the data flow volume is equal to or more than 10 pieces/minute, a mask that omits a period of time equal to or shorter than one minute of the time-of-day will be applied.

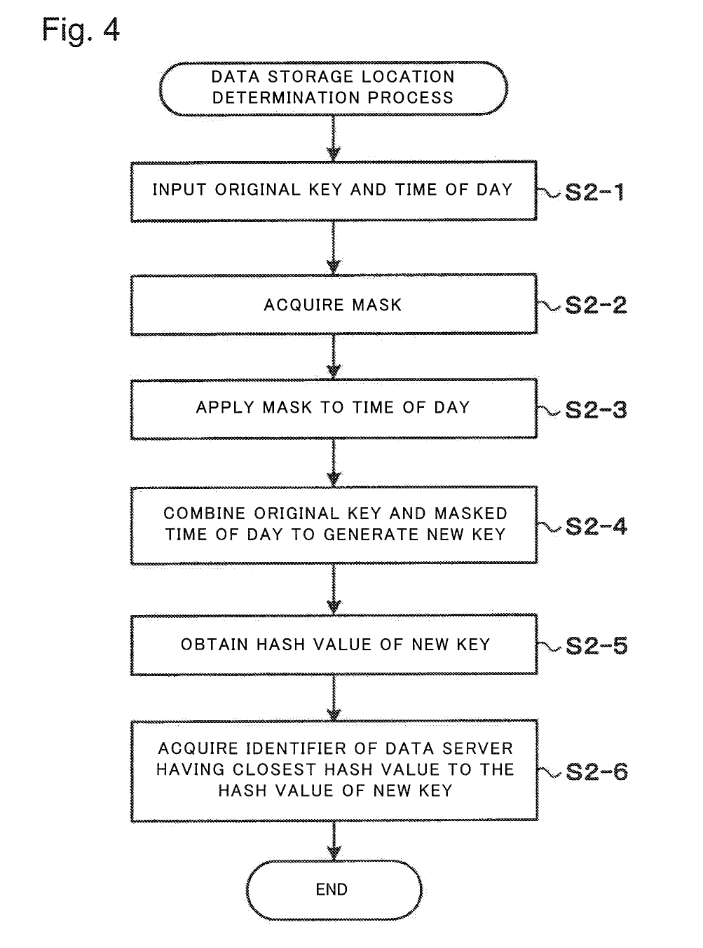

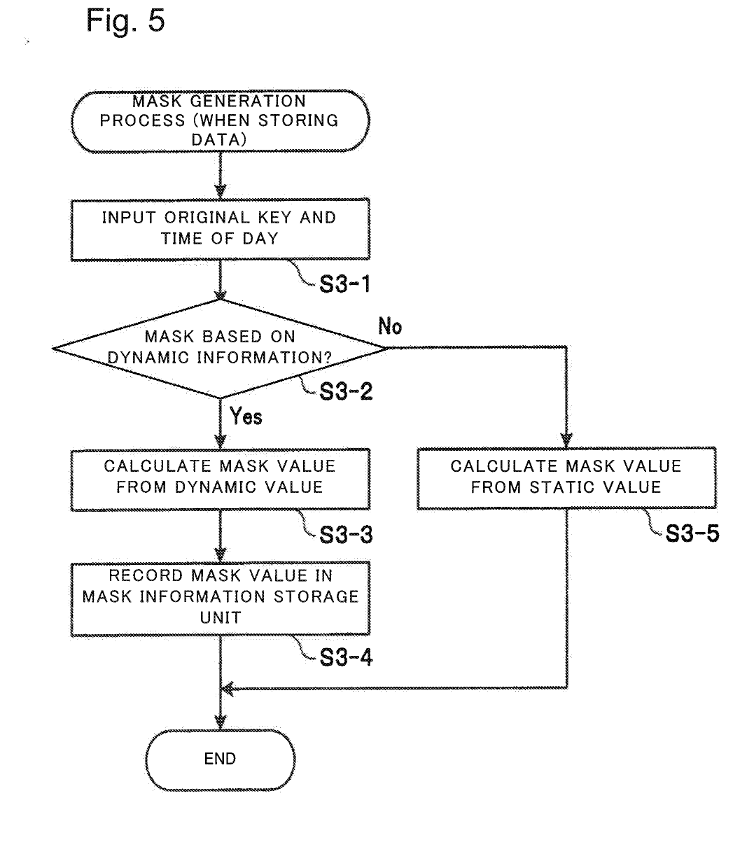

Referring first to FIG. 4 and FIG. 5, the process of determining the data storage location when storing the data will be described, in the order of Sensor A, Sensor B, and Sensor C.

FIG. 4 is a flowchart showing the process of determining the storage location when storing the data. The process shown in FIG. 4 corresponds to steps S1-2 to S1-4 of FIG. 3. FIG. 5 is a flowchart showing the process of generating a mask when storing the data. The mask generation process shown in FIG. 5 is triggered by step S2-2 of FIG. 4.

[Storing Data from Sensor A]

Here, it will be assumed that data containing (sensor identifier, time-of-day)=(Sensor A, 2013/02/12/10:10:02) has been inputted to the key generation unit 102, as information accompanying the data storage request (FIG. 4: step S2-1). The inputted time-of-day may be added by the sensor, or by the receiving node 10 or other repeating nodes. The granularity of the time-of-day may be coarser or finer than the foregoing examples, as the case may be.

The key generation unit 102 first requests the mask generation unit 101 for the mask to be applied to the time-of-day, and acquires the mask (FIG. 4: step S2-2).

When the key generation unit 102 makes the request for the mask, the information of (sensor identifier, time-of-day)=(Sensor A, 2013/02/12/10:10:02) is inputted in the mask generation unit 101 (FIG. 5: step S3-1).

The mask generation unit 101 decides whether the mask for the sensor identifier is generated from dynamic information, on the basis of the mask generation rule 1011 (FIG. 5: step S3-2). In this example, the mask for the sensor identifier Sensor A is statically determined so as to always omit a time equal to or shorter than one minute of the time-of-day. Therefore, the mask generation unit 101 generates a mask that omits a time equal to or shorter than one minute of the inputted time-of-day, and returns the mask to the key generation unit 102 together with the processing result (FIG. 5: step S3-5).

Upon receipt of the mask from the mask generation unit 101, the key generation unit 102 applies the acquired mask to the inputted time-of-day (FIG. 4: step S2-3). In this example, the masked time-of-day “2013/02/12/10:10:00” is obtained by such application of the mask.

Then the key generation unit 102 combines the original key and the masked time-of-day, thereby generating a new key (FIG. 4: step S2-4). Examples of the combining method include simply connecting the byte strings of the sensor identifier and the masked time-of-day.

Then the destination-node calculation unit 103 applies the new key to a predetermined hash function, thereby identifying a destination node

(FIG. 4: steps S2-5 and S2-6). For example, the consistent hashing may be employed to identify the destination node from the new key.

Through the mentioned process, the destination node is obtained on the basis of the sensor identifier and the time-of-day. In this example, the same new key and the same destination node can be obtained, with respect to data accompanying the following information, received thereafter:
(sensor identifier, time-of-day)=(Sensor A, 2013/02/12/10:10:03),
(sensor identifier, time-of-day)=(Sensor A, 2013/02/12/10:10:04), . . . , and
(sensor identifier, time-of-day)=(Sensor A, 2013/02/12/10:10:59).

Therefore, the data of close times-of-day can be stored in the same destination node.

With respect to data having the time-of-day of 2013/02/12/10:11:00 or later, a different new key and a different destination node are obtained, and hence the data can be dispersed.

[Storing Data from Sensor B]

Hereunder, the case where the original key is Sensor B will be described. It will be assumed that data containing (sensor identifier, time-of-day)=(Sensor B, 2013/02/12/10:10:02) has been inputted to the key generation unit 102, as information accompanying the data storage request (FIG. 4: step S2-1).

The key generation unit 102 requests the mask generation unit 101 for the mask to be applied to the time-of-day, and acquires the mask, as in the case of Sensor A (FIG. 4: step S2-2).

In this example, the information of (sensor identifier, time-of-day)=(Sensor B, 2013/02/12/10:10:02) is inputted to the mask generation unit 101 (FIG. 5: step S3-1).

The mask generation unit 101 decides, as in the case of Sensor A, whether the mask for the sensor identifier is generated from dynamic information, on the basis of the mask generation rule 1011 (FIG. 5: step S3-2). In this example, the mask for the sensor identifier Sensor B is determined on the basis of whether the inputted time-of-day is in the morning or afternoon, which is the static information identifiable from the time-of-day of storing the data. Since the inputted time-of-day is in the morning, the mask generation unit 101 generates a mask that omits a time equal to or shorter than 30 minutes of the inputted time-of-day, and returns the mask to the key generation unit 102 together with the processing result (FIG. 5: step S3-5).

Upon receipt of the mask from the mask generation unit 101, the key generation unit 102 applies the acquired mask to the inputted time-of-day (FIG. 4: step S2-3). In this example, the masked time-of-day “2013/02/12/10:00:00” is obtained by such application of the mask.

Thereafter, the same process as the case of storing the data from Sensor A is performed (FIG. 4: steps S2-4 to S2-6).

Through the mentioned process, the destination node is obtained on the basis of the sensor identifier and the time-of-day. In this example, the same new key and the same destination node can be obtained, with respect to data accompanying the following information, received thereafter:
(sensor identifier, time-of-day)=(Sensor B, 2013/02/12/10:10:03),
(sensor identifier, time-of-day)=(Sensor B, 2013/02/12/10:10:04), . . . , and
(sensor identifier, time-of-day)=(Sensor B, 2013/02/12/10:29:59),

Therefore, the data of close times-of-day can be stored in the same destination node.

With respect to data having the time-of-day of 2013/02/12/10:30:00 or later, a different new key and a different destination node are obtained, and hence the data can be dispersed.

In addition, with respect to data having a time-of-day in the afternoon, the value of the new key varies every minute as in the case of Sensor A, and hence the data can be dispersed by the minute.

[Storing Data from Sensor C]

Hereunder, the case where the original key is Sensor C will be described. It will be assumed that data containing (sensor identifier, time-of-day)=(Sensor C, 2013/02/12/10:10:02) has been inputted to the key generation unit 102, as information accompanying the data storage request (FIG. 4: step S2-1).

The key generation unit 102 requests the mask generation unit 101 for the mask to be applied to the time-of-day, and acquires the mask, as in the case of Sensor A (FIG. 4: step S2-2).

In this example, the information of (sensor identifier, time-of-day)=(Sensor C, 2013/02/12/10:10:02) is inputted to the mask generation unit 101 (FIG. 5: step S3-1).

The mask generation unit 101 decides, as in the case of Sensor A, whether the mask for the sensor identifier is generated from dynamic information, on the basis of the mask generation rule 1011 (FIG. 5: step S3-2). In this example, the mask for the sensor identifier Sensor C is determined on the basis of the data flow volume, which is dynamic information. Here, it will be assumed that the data flow volume is 10 pieces/minute. Accordingly, the mask generation unit 101 generates a mask that converts the data by omitting a time equal to or shorter than 10 minutes of the inputted time-of-day, and returns the mask to the key generation unit 102 together with the processing result (FIG. 5: step S3-3).

The measurement method of the data flow volume is not specifically limited. As an example, the receiving node 10 for receiving data from Sensor C may be fixed, and the data flow volume may be counted each time data arrives.

In this example, in addition, the mask generation unit 101 records the sensor identifier, the time-of-day, and the mask value in the mask information storage unit 104 (FIG. 5: step S3-4). However, the information to be recorded in the mask information storage unit 104 is not limited to those cited above. It suffices that the information allows the mask to be reproduced when acquiring the data, from the inputted original key and time-of-day. In this example, for example a set of a rule identifier, the time-of-day, and the mask value, or a set of the sensor identifier, the time-of-day, and the data flow volume may be recorded.

Upon receipt of the mask from the mask generation unit 101, the key generation unit 102 applies the acquired mask to the inputted time-of-day (FIG. 4: step S2-3). In this example, the masked time-of-day “2013/02/12/10:10:00” is obtained by such application of the mask.

Thereafter, the same process as the case of storing the data from Sensor A is performed (FIG. 4: steps S2-4 to S2-6).

Through the mentioned process, the destination node is obtained on the basis of the sensor identifier and the time-of-day. In this example, the same new key and the same destination node can be obtained, with respect to data accompanying the following information, received thereafter:
(sensor identifier, time-of-day)=(Sensor C, 2013/02/12/10:10:03),
(sensor identifier, time-of-day)=(Sensor C, 2013/02/12/10:10:04), . . . , and
(sensor identifier, time-of-day)=(Sensor C, 2013/02/12/10:09:59)

When the data flow volume becomes 10 pieces/minute or more, the value of the new key is thereafter varied by the minute, until the data flow volume again decreases to less than 10 pieces/minute. Thus, the arrangement according to this example enables the time unit by which the data is to be dispersed to be varied depending on the data flow volume. For example, the data can be dispersed by the minute when the data flow volume is large, and the data can be dispersed every 10 minutes when the data flow volume is small. Therefore, the amount of data stored in each of the servers can be levelled off, despite the data flow volume being different depending on the time zone.

As described thus far, the arrangement according to this exemplary embodiment allows the data generated at times-of-day close to each other to be stored in the same storage location, while dispersing the data over a plurality of data servers. Moreover, the value of the mask to be applied to the time-of-day can be varied in accordance with the mask generation rule, and therefore the dispersion mode can be finely adjusted depending on the data acquisition pattern. Therefore, even when the data is unevenly generated depending on the sensor and the time zone, the unevenness can be smoothed by specifying the mask generation rule so as to vary the value of the mask depending on the time zone and other factors.

Hereunder, the process of determining the data storage location when acquiring the data will be described, in the order of Sensor A, Sensor B, and Sensor C. First, the data acquisition process performed when the data to be acquired is directly specified by the original key and the time-of-day will be described. The data acquisition process performed when the data to be acquired is specified by a range of the original key and the time-of-day will be subsequently described.

### [Data Acquisition by Direct Specification]

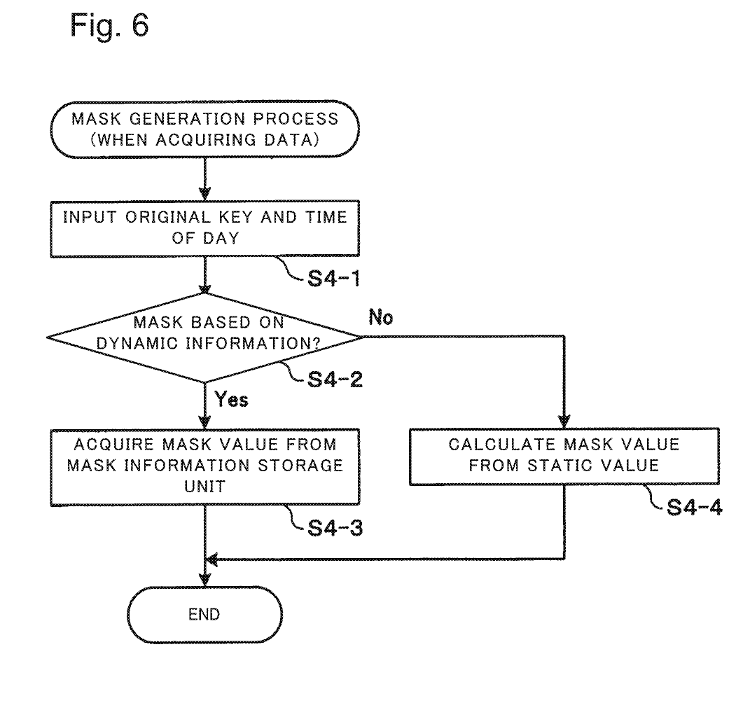

FIG. 6 is a flowchart showing the process of generating a mask when acquiring data by direct specification. The process of determining the data storage location when the time-of-day of the data to be acquired is directly specified may be performed in the same way as the case of storing the data, except for the mask acquisition process.

### [Acquiring Data of Sensor A]

Here, it will be assumed that data containing (sensor identifier, time-of-day)=(Sensor A, 2013/02/12/10:10:02) has been inputted to the key generation unit 102, as information accompanying the data acquisition request (FIG. 4: step S2-1). The inputted time-of-day is assumed to be acquired from the data acquisition request. The granularity of the time-of-day may be coarser or finer than the foregoing examples, as the case may be.

In this example, (sensor identifier, time-of-day)=(Sensor A, 2013/02/12/10:10:02) is inputted in the mask generation unit 101 (FIG. 6: step S4-1).

The mask generation unit 101 decides whether the mask for the sensor identifier is generated from dynamic information, on the basis of the mask generation rule 1011 (FIG. 6: step S4-2). In this example, the mask for the sensor identifier Sensor A is statically determined so as to always omit a time equal to or shorter than one minute of the time-of-day. Therefore, the mask generation unit 101 generates a mask that omits a time equal to or shorter than one minute of the inputted time-of-day, and returns the mask to the key generation unit 102 together with the processing result (FIG. 6: step S4-4).

Upon receipt of the mask from the mask generation unit 101, the key generation unit 102 applies the acquired mask to the inputted time-of-day (FIG. 4: step S2-3). In this example, the masked time-of-day “2013/02/12/10:10:00” is obtained by such application of the mask.

Then the key generation unit 102 combines the original key and the masked time-of-day, thereby generating a new key, as in the case of storing the data (FIG. 4: step S2-4).

Then the destination-node calculation unit 103 applies the new key to a predetermined hash function, thereby identifying a destination node (FIG. 4: steps S2-5 and S2-6). When the value of the new key is the same, the destination node obtained at this step is the same as the destination node obtained when storing the data.

Through the mentioned process, the destination node storing the data to be acquired is obtained, on the basis of the sensor identifier and the time-of-day. Here, the destination node (data server 20) obtained in this example may contain the data for which the original key of “Sensor A” and time-of-day between “2013/02/12/10:10:00” and “2013/02/12/10:10:59” were specified at the time of storing data. In this example, however, the desired data can be obtained by specifying the inputted information of the original key and time-of-day, when accessing the data server 20 identified as the destination node.

[Acquiring Data of Sensor B]

Hereunder, the case where the original key is Sensor B will be described. It will be assumed that data containing (sensor identifier, time-of-day)=(Sensor B, 2013/02/12/10:10:02) has been inputted to the key generation unit 102, as information accompanying the data acquisition request (FIG. 4: step S2-1).

In this example, the information of (sensor identifier, time-of-day)=(Sensor B, 2013/02/12/10:10:02) is inputted to the mask generation unit 101 (FIG. 6: step S4-1).

The mask generation unit 101 decides whether the mask for the sensor identifier is generated from dynamic information, on the basis of the mask generation rule 1011 (FIG. 6: step S4-2). In this example, the mask for the sensor identifier Sensor B is determined on the basis of whether the inputted time-of-day is in the morning or afternoon, which is static information. Since the inputted time-of-day is in the morning, the mask generation unit 101 generates a mask that omits a time equal to or shorter than 30 minutes of the inputted time-of-day, and returns the mask to the key generation unit 102 together with the processing result (FIG. 6: step S4-4).

Upon receipt of the mask from the mask generation unit 101, the key generation unit 102 applies the acquired mask to the inputted time-of-day (FIG. 4: step S2-3). In this example, the masked time-of-day “2013/02/12/10:00:00” is obtained by such application of the mask.

Thereafter, the same process as the case of acquiring the data of Sensor A is performed (FIG. 4: steps S2-4 to S2-6).

Through the mentioned process, the destination node storing the data to be acquired is obtained, on the basis of the sensor identifier and the time-of-day. Here, the destination node obtained in this example may contain the data for which the original key of “Sensor B” and time-of-day between “2013/02/12/10:10:00” and “2013/02/12/10:29:59” were specified at the time of storing data. In this example, however, the desired data can be obtained by specifying the inputted information of the original key and time-of-day, when accessing the data server 20 identified as the destination node.

### [Acquiring Data of Sensor C]

Hereunder, the case where the original key is Sensor C will be described. It will be assumed that data containing (sensor identifier, time-of-day)=(Sensor C, 2013/02/12/10:10:02) has been inputted to the key generation unit 102, as information accompanying the data acquisition request (FIG. 4: step S2-1).

In this example, the information of (sensor identifier, time-of-day)=(Sensor C, 2013/02/12/10:10:02) is inputted to the mask generation unit 101 (FIG. 6: step S4-1).

The mask generation unit 101 decides whether the mask for the sensor identifier is generated from dynamic information, on the basis of the mask generation rule 1011 (FIG. 6: step S4-2). In this example, the mask for the sensor identifier Sensor C is determined on the basis of the data flow volume, which is dynamic information. Accordingly, the mask generation unit 101 acquires the mask applied at the time of storing the data, using the set of the original key and time-of-day inputted by the mask information storage unit 104 as the key. The mask generation unit 101 then returns the mask to the key generation unit 102 together with the processing result (FIG. 6: step S4-3). In this example, it is assumed that the information of the mask generated at the time of storing the data accompanying the information of (Sensor C, 2013/02/12/10:10:02) is stored. Thus, the mask generation unit 101 may acquire the mask information on the basis of the set of the original key and time-of-day, and return the mask to the key generation unit 102 together with the processing result.

In this process, the mask generation unit 101 may return the processing result indicating “no data”, when the information of the mask applied to the data accompanying the same original key and time-of-day is not found in the mask information storage unit 104. Alternatively, the mask generation unit 101 may be configured to return, in such a case, the information of the mask applied to the data accompanying a close time-of-day. In this example, as result of acquiring the information of the mask applied to the data for which (Sensor C, 2013/02/12/10:10:02) was specified when storing data from the mask information storage unit 104, the mask that converts the data by omitting a time equal to or shorter than 10 minutes of the inputted time-of-day is provided.

Upon receipt of the mask from the mask generation unit 101, the key generation unit 102 applies the acquired mask to the inputted time-of-day (FIG. 4: step S2-3). In this example, the masked time-of-day “2013/02/12/10:10:00” is obtained by such application of the mask.

Thereafter, the same process as the case of acquiring the data of Sensor A is performed (FIG. 4: steps S2-4 to S2-6).

Through the mentioned process, the destination node storing the data to be acquired is obtained, on the basis of the sensor identifier and the time-of-day. Here, the destination node obtained in this example may contain the data for which the original key of “Sensor C” and time-of-day between “2013/02/12/10:10:00” and “2013/02/12/10:10:59” were specified at the time of storing data. In addition, the destination node may also contain the data for which the original key of “Sensor C” and time-of-day between “2013/02/12/10:10:00” and “2013/02/12/10:19:59” were specified, depending on the data flow volume at the time of storing data. In this example, however, the desired data can be obtained by specifying the inputted information of the original key and time-of-day, when accessing the data server 20 identified as the destination node.

### [Data Acquisition by Range Specification]

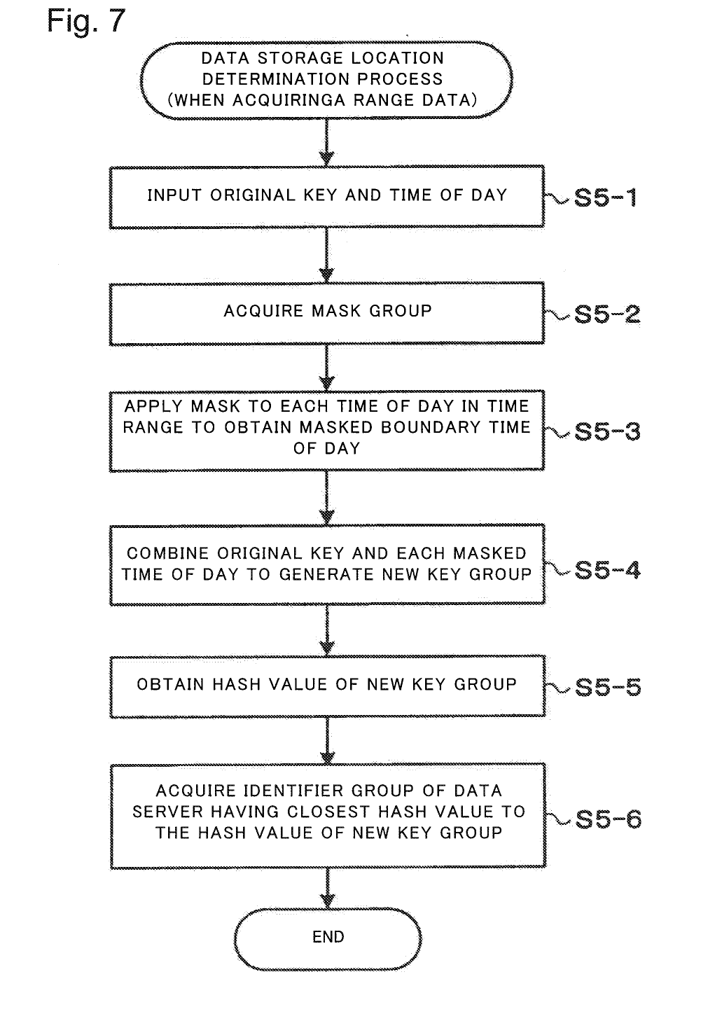

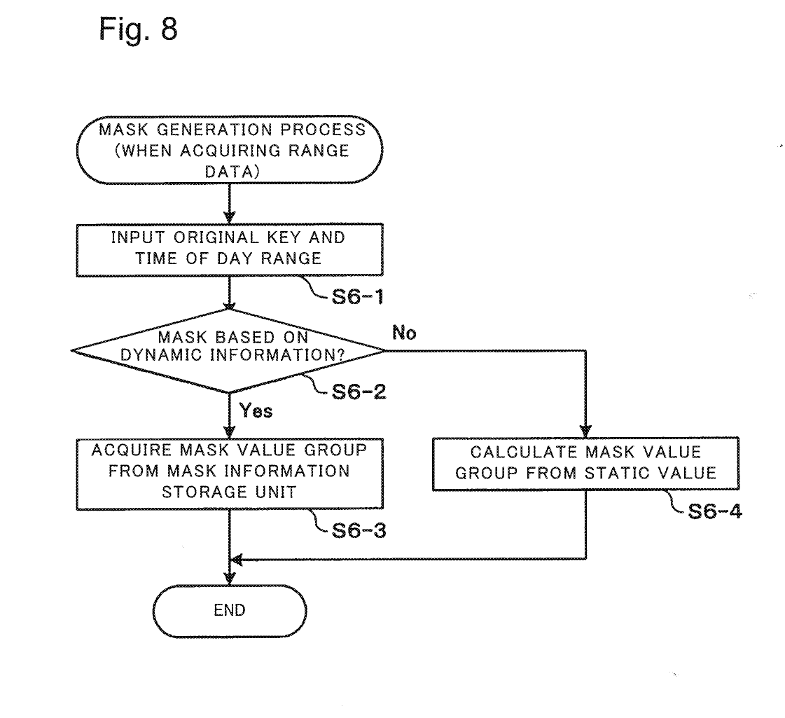

FIG. 7 is a flowchart showing the process of determining the storage location when acquiring data by range specification. FIG. 8 is a flowchart showing the process of generating a mask when acquiring data by range specification. The mask generation process shown in FIG. 8 is triggered by step S5-2 of FIG. 7. Hereunder, the process of determining the data storage location when acquiring the data by range specification will be described, with respect to Sensor A.

### [Acquiring Data of Sensor A by Range Specification]

Here, it will be assumed that a receiving node 10 has received a range data acquisition request specifying Sensor A as sensor identifier and a range of time-of-day between 2013/02/12/10:10:00 and 2013/02/12/11:59:59.

In such a case, for example (sensor identifier, time-of-day)=(Sensor A, 2013/02/12/10:10:00) to (Sensor A, 2013/02/12/11:59:59) is inputted to the key generation unit 102, as information accompanying the data acquisition request (FIG. 7: step S5-1).

First, the key generation unit 102 requests the mask generation unit 101 for a mask group to be applied to the specified time-of-day range, and acquires the mask group (FIG. 7: step S5-2).

When the key generation unit 102 makes the request for the mask group, (sensor identifier, time-of-day)=(Sensor A, 2013/02/12/10:10:00 to 2013/02/12/11:59:59) is inputted to the mask generation unit 101 (FIG. 8: step S6-1).

The mask generation unit 101 decides whether the mask for the sensor identifier is generated from dynamic information, on the basis of the mask generation rule 1011 (FIG. 8: step S6-2). In this example, the mask for the sensor identifier Sensor A is statically determined so as to always omit a time equal to or shorter than one minute of the time-of-day. Therefore, the mask generation unit 101 generates a mask that omits a time equal to or shorter than one minute of the inputted time-of-day, and returns the mask to the key generation unit 102 together with the processing result (FIG. 8: step S6-4).

At this point, the mask generation unit 101 returns all the masks that may be applied to the respective times-of-day included in the time-of-day range. In this example, the same mask may be applied to each time-of-day included in the inputted time-of-day range, and therefore the mask generation unit 101 may return one mask. In the case where the time range to which the mask is to be applied is determined, for example morning and afternoon, the mask generation unit 101 may return the mask together with the information of the time range to which the mask is to be applied.

Upon receipt of the mask group from the mask generation unit 101, the key generation unit 102 acquires masked boundary times-of-day using the acquired mask group (FIG. 7: step S5-3). Here, the masked boundary time-of-day will be defined as the masked time-of-day group obtained when the provided mask group is applied to all the times-of-day included in the time-of-day range, from which duplications are excluded. In this example, the mask that always omits a time equal to or shorter than one minute of the inputted time-of-day is obtained. Therefore, the times-of-day at intervals of one minute between:

2013/02/12/10:10:00 and 2013/02/12/11:59:00

are obtained as masked boundary times-of-day. In other words, totally 110 items of times-of-day are obtained.

Then the key generation unit 102 combines the original key and the masked boundary times-of-day, thereby generating a new key group, as in the case of storing the data (FIG. 7: step S5-4). Since 110 items of masked boundary times-of-day are obtained in this example, 110 items of new keys are generated.

Then the destination-node calculation unit 103 applies each of the new keys to a predetermined hash function, thereby identifying a destination node group (FIG. 7: step S5-5 to S5-6). The identification method of the destination node from the new key may be the same as in the case of storing the data.

Through the mentioned process, the destination node group storing the data to be acquired is obtained, on the basis of the sensor identifier and the time-of-day range. The receiving node 10 may make the data acquisition request to each data server 20 included in the obtained destination node group, with the specification of the original key time-of-day range. Through such a process, the desired data can be efficiently acquired. This is because the data group generated by the same sensor in the times-of-day close to each other, and stored in the same data server 20, can be collectively acquired.

The range data of Sensor A can be thus acquired, and also the range data of Sensor B and Sensor C, to which different mask rules are applied, can be equally acquired through the process shown in FIG. 7 and FIG. 8.

### [Acquiring Data of Sensor B by Range Specification]

In the case of Sensor B, the mask generation unit 101 may provide, for example, the following mask information as mask group, in response to a range data acquisition request specifying the times-of-day as between:

2013/02/12/10:10:00 and 2013/02/12/11:59:59.

Since the times-of-day included in the range specification are all in the morning, the mask generation unit 101 may return the mask that converts the data by omitting a time equal to or shorter than 30 minutes.

Upon receipt of the mentioned mask group, the key generation unit 102 may acquire the following masked boundary times-of-day. Since the mask that omits a time equal to or shorter than 30 minutes of the inputted time-of-day is acquired, the key generation unit 102 acquires the times-of-day at intervals of 30 minutes between:

2013/02/12/10:10:00 and 2013/02/12/11:30:00

as masked boundary times-of-day. In other words, the key generation unit 102 acquires totally four items of times-of-day.

Here, in the case where the time-of-day range is between:

2013/02/12/10:10:00 and 2013/02/12/13:59:59,

the mask generation unit 101 may return the mask that converts the data by omitting a time equal to or shorter than 30 minutes with respect to the times-of-day in the morning between:

2013/02/12/10:10:00 and 2013/02/12/11:59:59,

and the mask that converts the data by omitting a time equal to or shorter than one minute with respect to the times-of-day in the afternoon between:

2013/02/12/12:00:00 and 2013/02/12/13:59:59.

Upon receipt of the mentioned mask group, the key generation unit 102 may acquire the following masked boundary times-of-day. The key generation unit 102 may acquire, as masked boundary times-of-day, the times-of-day at intervals of 30 minutes between:

2013/02/12/10:10:00 and 2013/02/12/11:30:00,

in other words four items of times-of-day, and the times-of-day at intervals of one minute between:

2013/02/12/12:00:00 and 2013/02/12/13:59:00,

in other words 120 items of times-of-day, totally 124 items of times-of-day.

### [Acquiring Data of Sensor C by Range Specification]

In the case of Sensor C, the mask generation unit 101 may provide information of the mask obtained for example through the following process, as mask group. The mask generation unit 101 may search the mask applied when storing the data to each set of the original key and time-of-day included in the range specification inputted by the mask information storage unit 104. Then the mask generation unit 101 may return a combination of the mask identified with the information of the acquired masks and the information of the time-of-day to which the acquired mask is applied (FIG. 8: step S6-3). In the case where the time-of-day to which the mask is to be applied is determined, the mask generation unit 101 may return the mask information together with the information of the time-of-day to which the mask is to be applied.

For example, the mask generation unit 101 may acquire from the mask information storage unit 104 the information to the effect that the mask that converts the data by omitting a time equal to or shorter than 10 minutes of the time-of-day has been generated. This is because the data flow volume was less than 10 pieces/minute with respect to the data having the sensor identifier of Sensor C and the time-of-day between 2013/02/12/10:10:00 and 2013/02/12/11:29:59. In addition, the mask generation unit 101 may acquire the information to the effect that the mask that converts the data by omitting a time equal to or shorter than one minute of the time-of-day has been generated. This is because the data flow volume was equal to or more than 10 pieces/minute with respect to the data having the sensor identifier of Sensor C and the time-of-day between 2013/02/12/11:30:00 to 2013/02/12/11:59:59. In such a case, the mask generation unit 101 may return the mask that converts the data by omitting a time equal to or shorter than 10 minutes of the time-of-day between 2013/02/12/10:10:00 and 2013/02/12/11:29:59. In addition, the mask generation unit 101 may return the mask that converts the data by omitting a time equal to or shorter than one minute of the time-of-day between 2013/02/12/11:30:00 and 2013/02/12/11:59:59. In the case where no data has been generated at any of the times-of-day, such time-of-day may be excluded from those to which the mask is to be applied.

Upon receipt of the mentioned mask group, the key generation unit 102 may acquire the following masked boundary times-of-day. The key generation unit 102 may acquire, as masked boundary times-of-day, the times-of-day at intervals of 10 minutes between:

2013/02/12/10:10:00 and 2013/02/12/11:20:00,

in other words eight items of times-of-day, and the times-of-day at intervals of one minute between:

2013/02/12/11:30:00 and 2013/02/12/11:59:00,

in other words 30 items of times-of-day, totally 38 items of times-of-day.

As described thus far, with the configuration according to this exemplary embodiment the data retention amount per server can be levelled off. In addition, the number of accessing times to the server can be reduced when a certain mass of data generated around a specific time-of-day and including a specific original key. Therefore, both the dispersion performance of the data storage locations and the access efficiency in data acquisition can be satisfied at the same time.

Although the mask is varied depending on the sensor identifier, the time zone, and the data flow volume in the foregoing exemplary embodiment, the mask may be varied depending on different factors. For example, the mask may be varied depending on the number of data servers 20 included in the system configuration information. In the case where the number of data servers 20 is switched, for example, between 10 servers and 100 servers, the width of the masked time-of-day is narrowed, in other words the interval to omit the time is shortened, when 100 servers are available. By doing so, the storage location can be more frequently switched among the 100 servers.

Alternatively, the mask may be varied depending on, for example, the type of the sensor. When handling, for example, data from an acceleration sensor that frequently generates the data, the width of the masked time-of-day is narrowed so as to more frequently switch the data server 20 in which the data is to be stored. In contrast, when handling data from a temperature sensor that does not generate the data so often, the width of the masked time-of-day is widened so as to increase the amount of data stored in one data server 20.

Further, the mask may be varied depending on, for example, the installation site of the sensor. For example, for a motion sensor for detecting a human body that is located in downtown and hence frequently generates data, the width of the masked time-of-day is narrowed so as to more frequently switch the data server 20 in which the data is to be stored. For a motion sensor that is located in suburbs and hence does not generate the data so often, the width of the masked time-of-day is widened so as to increase the amount of data stored in one data server 20.

### Second Exemplary Embodiment

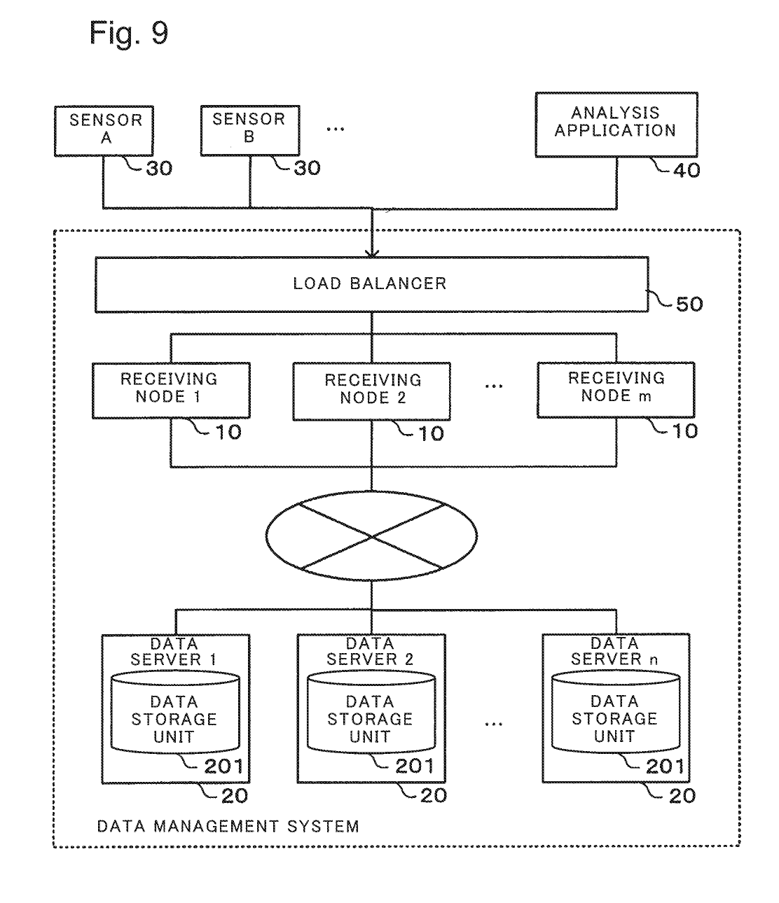

Hereunder, a second exemplary embodiment of the present disclosure will be described with reference to the drawings. FIG. 9 is a block diagram showing a configuration of a data management system according to the second exemplary embodiment of the present disclosure. The data management system shown in FIG. 9 is different from the first exemplary embodiment shown in FIG. 1 in including a load balancer 50. Although FIG. 9 illustrates just one load balancer 50, two or more load balancers 50 may be provided.

In order to handle a large amount of sensor data, it is preferable to disperse the access to the receiving node 10. In this exemplary embodiment, the load balancer 50 serves for this purpose. In other words, load balancer 50 serves to disperse the access from outside to the receiving node 10.

The load balancer 50 may determine the receiving node 10 to be accessed for example by round robin method, to disperse the access to the receiving node 10. For example, the load balancer 50 may return, in response to an access from the storage requesting node and the acquisition requesting node, the information of the receiving node 10 determined as access destination, to the requesting node. Alternatively, the load balancer 50 may relay the received access to the receiving node 10 determined as access destination.

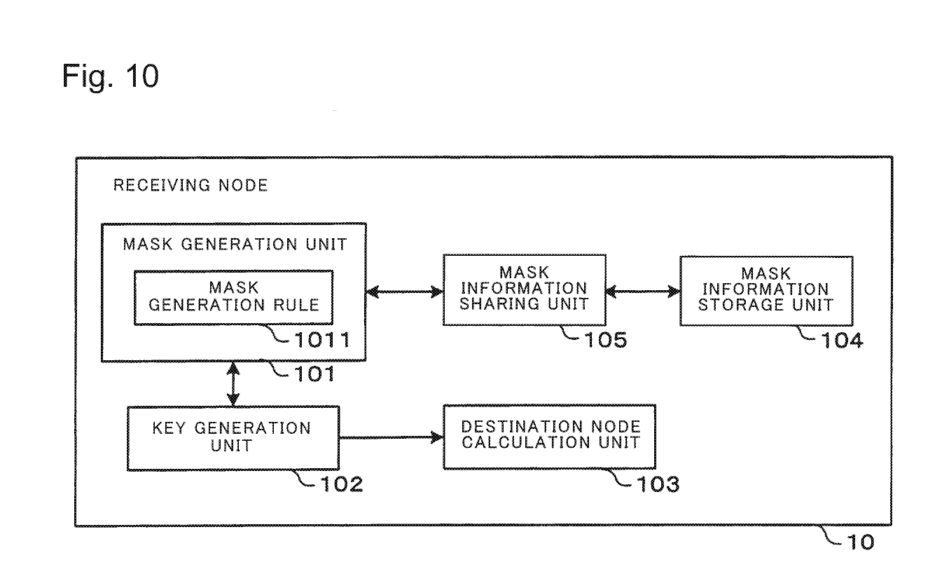

In this exemplary embodiment, a system for sharing the mask information for processing the data among the receiving nodes 10 is necessary. FIG. 10 is a block diagram showing a functional configuration of the receiving node 10 according to this exemplary embodiment. As shown in FIG. 10, the receiving node 10 according to this exemplary embodiment may further include a mask information sharing unit 105.

The mask information sharing unit 105 performs a process to share the mask information for processing the data with other receiving nodes 10. For example, the mask information sharing unit 105 may acquire information of a mask generated based on a mask generation rule or dynamic information not stored in the belonging node. Such acquisition may be achieved by making an inquiry to other receiving nodes 10 or a non-illustrated shared database provided in the system.

The mask generation unit 101 acquires the information of the mask generated based on the mask generation rule or dynamic information, through the mask information sharing unit 105 if need be. The mask information sharing unit 105 may further make periodical inquiries to other receiving nodes 10, to thereby update the mask generation rule, as well as the mask information stored in the mask information storage unit 104.

When handling the mask determined on the basis of the dynamic information, such as the mask for the data from Sensor C, the load balancer 50 may be configured to allocate such data to a specific receiving node 10. Alternatively, the load balancer 50 may possess a system for sharing the dynamic information such as data flow volume among the receiving nodes 10. In addition, the load balancer 50 may measure the number of data generation times in a predetermined time and register the value in the shared database. In this case, each of the receiving nodes 10 can individually calculate the data flow volume on the basis of the information registered in the shared database.

The remaining part of the system is the same as that of the first exemplary embodiment.

As described above, the configuration according to this exemplary embodiment allows also the access to the receiving node 10 to be dispersed, thereby further improving the efficiency in data processing, compared with the first exemplary embodiment.

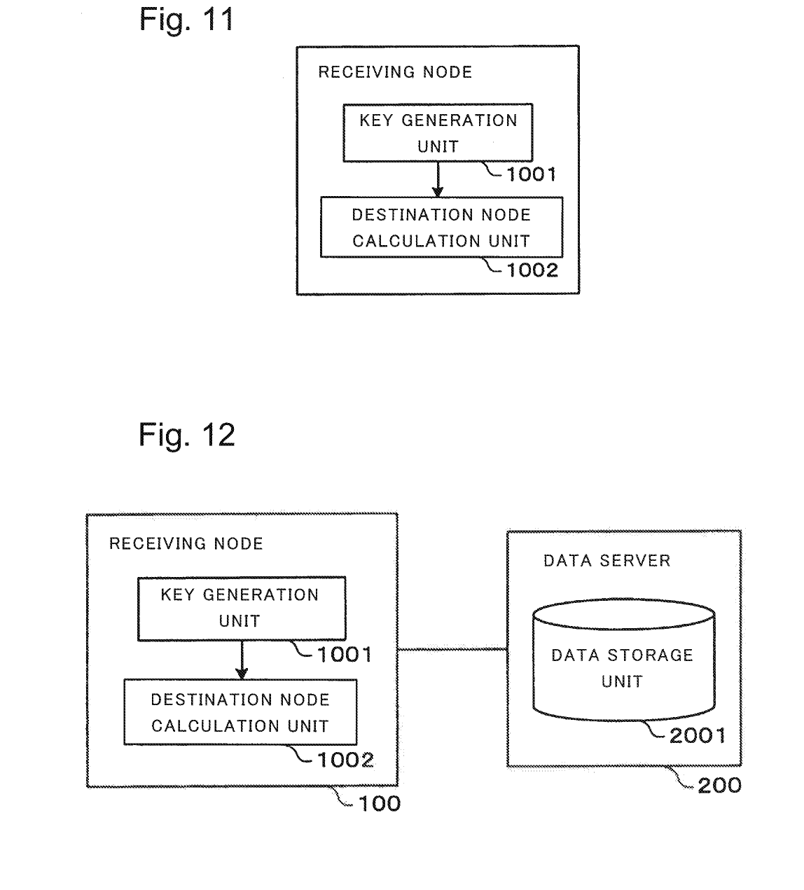

Hereunder, a minimum configuration of the receiving node according to the present disclosure will be described. FIG. 11 is a block diagram showing a minimum configuration of the receiving node according to the present disclosure.

As shown in FIG. 11, the receiving node according to the present disclosure includes a key generation unit 1001 and a destination-node calculation unit 1002, as minimum necessary components.

In the receiving node having the minimum configuration as shown in FIG. 11, the key generation unit 1001 (for example, key generation unit 101) generates a new key using a specified data key and a masked time-of-day obtained by applying a mask to a specified time-of-day.

The destination-node calculation unit 1002 (for example, destination-node calculation unit 103) determines the data server in which the data is to be stored, using the new key generated by the key generation unit 1001.

The receiving node having the minimum configuration generates a new key using the original key of the data and the masked time-of-day smaller in granularity than the time-of-day information. Accordingly, the server in which the data is to be stored can be switched in various patterns in terms of time width or time-of-day, though depending on the time zone to a certain extent. Consequently, both the dispersion performance of the data storage locations and the access performance in data acquisition can be satisfied at the same time.

FIG. 12 is a block diagram showing a minimum configuration of the data management system according to the present disclosure. As shown in FIG. 12, the data management system according to the present disclosure includes one or more data servers 200 and one or more receiving nodes 100, as minimum necessary components.

In the data management system having the minimum configuration as shown in FIG. 13, the data server 200 includes a data storage unit that stores data.

The receiving node 100 includes the key generation unit 1001 and the destination-node calculation unit 1002. The key generation unit 1001 and the destination-node calculation unit 1002 may be the same ones as those described above.

In the data management system having the minimum configuration, the receiving node 100 generates a new key using the original key of the data and the masked time-of-day smaller in granularity than the time-of-day information. Accordingly, the server in which the data is to be stored can be switched in various patterns in terms of time width or time-of-day, though depending on the time zone to a certain extent. Consequently, both the dispersion performance of the data storage locations and the access performance in data acquisition can be satisfied at the same time.

Although the present invention has been described with reference to the exemplary embodiments, the present invention is in no way limited to the foregoing exemplary embodiments. Various modifications obvious to those skilled in the art may be made to the configurations and specific details of the present invention, within the scope of the present invention.

A part or the whole of the foregoing exemplary embodiments may be expressed as, but is not limited to, the following supplementary notes.

### (Supplementary Note 1)

A receiving node that determines, upon receipt of a data storage request or a data acquisition request, a data server in which data is to be stored, the receiving node comprising:

key generation unit which generates a new key using a specified data key and a masked time-of-day acquired by applying a mask to a specified time-of-day; and destination node calculation unit which determines the data server in which the data is to be stored, using the new key generated by the key generation unit.

### (Supplementary Note 2)

The receiving node according to Supplementary Note 1, further comprising mask generation unit which generates, when the key and the time-of-day of the data are inputted, the mask to be applied to the time-of-day,

wherein the mask generation unit possesses a mask generation rule stipulating, in association with predetermined information, information of the mask to be generated, and generates the mask to be applied to the time-of-day in accordance with the mask generation rule.

### (Supplementary Note 3)

The receiving node according to Supplementary Note 2,

wherein the mask generation rule includes information in which information of a key value of the data and information of the mask to be generated are associated with each other, and

the mask generation unit generates a different mask depending on the key value of the data, in accordance with the mask generation rule.

### (Supplementary Note 4)

The receiving node according to Supplementary Note 2 or 3,

wherein the mask generation rule includes information in which information of static information identified from inputted information and the information of the mask to be generated are associated with each other, and

the mask generation unit generates a different mask on a basis of the static information identified from the inputted information, in accordance with the mask generation rule.

### (Supplementary Note 5)

The receiving node according to any one of Supplementary Notes 2 to 4,

wherein the mask generation rule includes information in which information of dynamic information content of which varies while the system is in operation and is hence unidentifiable from the inputted information, and the information of the mask to be generated are associated with each other, and

the mask generation unit generates a different mask on a basis of the dynamic information, in accordance with the mask generation rule.

### (Supplementary Note 6)

The receiving node according to Supplementary Note 5, further comprising mask information storage unit which stores information of the generated mask,

wherein the mask generation unit stores, in response to the data storage request, information that allows the mask generated on a basis of the inputted key and time-of-day of the data to be reproduced in the mask information storage unit, in a case where the mask generation unit has generated a different mask on a basis of the dynamic information, and

the mask generation unit generates, in response to the data acquisition request, the mask to be applied to the inputted time-of-day on a basis of the information stored in the mask information storage unit, in a case where the mask to be generated differs depending on the dynamic information.

### (Supplementary Note 7)

The receiving node according to any one of Supplementary Notes 1 to 6,

wherein the destination-node calculation unit compares a hash value obtained by inputting the new key generated by the key generation unit to a predetermined hash function, with a hash value obtained by inputting an identifier of each data server in the predetermined hash function, and determines the data server in which the data is to be stored, by a predetermined allocation method.

### (Supplementary Note 8)

A data management system comprising:

one or more data servers including data storage unit which stores data; and

one or more receiving nodes,

wherein each of the receiving nodes includes:

key generation unit which generates a new key using a specified data key and a masked time-of-day acquired by applying a mask to a specified time-of-day; and

destination node calculation unit which identifies the data server in which the data is to be stored, using the new key generated by the key generation unit.

### (Supplementary Note 9)

A data management method comprising causing a receiving node to:

generate a new key using a specified data key and a masked time-of-day acquired by applying a mask to a specified time-of-day, upon receipt of a data storage request or a data acquisition request; and

identify the data server in which the data is to be stored, using the new key generated by the key generation unit.

### (Supplementary Note 10)

The data management method according to Supplementary Note 9, further comprising:

possessing a mask generation rule stipulating relating mask generating information at a receiving node, in association with predetermined information,

generating, when the key and the time-of-day of the data are inputted, the mask to be applied to the time-of-day, and

obtaining the time-of-day of the mask to be applied to the time-of-day of the generated mask.

### (Supplementary Note 11)

The data management method according to Supplementary Note 10,

wherein the mask generation rule includes information in which information of a key value of the data and information of the mask to be generated are associated with each other, and

the receiving node generates a different mask depending on the key value of the data, in accordance with the mask generation rule.

### (Supplementary Note 12)

The data management method according to Supplementary Note 10 or 11,

wherein the mask generation rule includes information in which information of static information identified from inputted information and the information of the mask to be generated are associated with each other, and

the receiving node generates a different mask on a basis of the static information identified from the inputted information, in accordance with the mask generation rule.

### (Supplementary Note 13)

The data management method according to any one of Supplementary Notes 10 to 12,

wherein the mask generation rule includes information in which information of dynamic information content of which varies while the system is in operation and is hence unidentifiable from the inputted information, and the information of the mask to be generated are associated with each other, and

the receiving node generates a different mask on a basis of the dynamic information, in accordance with the mask generation rule.

### (Supplementary Note 14)

The data management method according to Supplementary Note 13, wherein the receiving node makes a mask information storage unit to store information, in response to the data storage request, that allows the mask generated on a basis of the inputted key and time-of-day of the data to be reproduced in the mask information storage unit, in a case where the mask generation unit has generated a different mask on a basis of the dynamic information, and

the receiving node generates, in response to the data acquisition request, the mask to be applied to the inputted time-of-day on a basis of the information stored in the mask information storage unit, in a case where the mask to be generated differs depending on the dynamic information.

### (Supplementary Note 15)

The data management method according to any one of Supplementary Notes 9 to 14,

wherein the receiving node compares a hash value obtained by inputting the new key generated by the key generation unit to a predetermined hash function, with a hash value obtained by inputting an identifier of each data server in the predetermined hash function, and determines the data server in which the data is to be stored, by a predetermined allocation method.

### (Supplementary Note 16)

A data management program configured to cause a computer to perform:

a key generation process including generating a new key using a specified data key and a masked time-of-day acquired by applying a mask to a specified time-of-day, upon receipt of a data storage request or a data acquisition request; and

a destination node calculation process including identifying the data server in which the data is to be stored, using the new key generated in the key generation process.

### (Supplementary Note 17)

The data management program according to Supplementary Note 16, further comprising:

a mask generation process which generates, when the key and the time-of-day of the data are inputted, the mask to be applied to the time-of-day,

wherein the mask generation process possesses a mask generation rule stipulating, in association with predetermined information, information of the mask to be generated, and generates the mask to be applied to the time-of-day in accordance with the mask generation rule.

### (Supplementary Note 18)

The data management program according to Supplementary Note 17,

wherein the mask generation rule includes information in which information of a key value of the data and information of the mask to be generated are associated with each other, and

the computer generates, in the mask generation process, a different mask depending on the key value of the data, in accordance with the mask generation rule.

### (Supplementary Note 19)

The data management program according to Supplementary Note 17 or 18,

wherein the mask generation rule includes information in which information of static information identified from inputted information and the information of the mask to be generated are associated with each other, and

the computer generates, in the mask generation process, a different mask on a basis of the static information identified from the inputted information, in accordance with the mask generation rule.

### (Supplementary Note 20)

The data management program according to any one of Supplementary Notes 17 to 19,

wherein the mask generation rule includes information in which information of dynamic information content of which varies while the system is in operation and is hence unidentifiable from the inputted information, and the information of the mask to be generated are associated with each other, and

the computer generates, in the mask generation process, a different mask on a basis of the dynamic information, in accordance with the mask generation rule.

### (Supplementary Note 21)

The data management program according to Supplementary Note 20, wherein

the computer makes, in the mask generation process, a mask information storage unit to store information, in response to the data storage request, that allows the mask generated on a basis of the inputted key and time-of-day of the data to be reproduced in the mask information storage unit, in a case where the mask generation unit has generated a different mask on a basis of the dynamic information, and

the computer generates, in response to the data acquisition request, the mask to be applied to the inputted time-of-day on a basis of the information stored in the mask information storage unit, in a case where the mask to be generated differs depending on the dynamic information.

### (Supplementary Note 22)

The data management program according to any one of Supplementary Notes 16 to 21,

wherein the computer compares, in the destination-node calculation process, a hash value obtained by inputting the new key generated by the key generation unit to a predetermined hash function, with a hash value obtained by inputting an identifier of each data server in the predetermined hash function, and determines the data server in which the data is to be stored, by a predetermined allocation method.

The present application claims priority to Japanese Patent Application No. 2013-125550 filed on Jun. 14, 2013, and the entire disclosure of which is incorporated herein.

While some aspects have been described hererinabove for implementing the present invention, the exemplary embodiments described above are intended to facilitate the understanding of the present invention and not intended to limit the present invention in its interpretation. The present invention may be modified and improved without departing from its spirits, and the equivalents thereof are included in the present invention.

### INDUSTRIAL APPLICABILITY

The present disclosure is suitably applicable to purposes of efficiently dispersing data generated in a large mass, without limitation to the sensor data.

### REFERENCE SIGNS LIST

10, 100 receiving node
101 mask generation unit
1011 mask generation rule
102, 1001 key generation unit
103, 1002 destination-node calculation unit
104 mask information storage unit
105 mask information sharing unit
20, 200 data server
201, 2001 data storage unit
30 sensor
40 analysis application
50 load balancer

What is claimed is:

1. A receiving node that determines, upon receipt of a data storage request or a data acquisition request, a data server in which data is to be stored, the receiving node comprising circuitry configured to:
key generation means which generate a new key using a specified data key and a masked time-of-day acquired by applying a mask to a specified time-of-day; and
destination node calculation means which determine the data server in which the data is to be stored, using the new key generated by the key generation.

2. The receiving node according to claim 1, the circuitry further configured to generate, when the key and the time-of-day of the data are inputted, the mask to be applied to the time-of-day,
wherein the mask generation possesses a mask generation rule stipulating, in association with predetermined information, information of the mask to be generated, and generates the mask to be applied to the time-of-day in accordance with the mask generation rule.

3. The receiving node according to claim 2,
wherein the mask generation rule includes information in which information of a key value of the data and information of the mask to be generated are associated with each other, and
the mask generation generates a different mask depending on the key value of the data, in accordance with the mask generation rule.

4. The receiving node according to claim 2,
wherein the mask generation rule includes information in which information of static information identified from inputted information and the information of the mask to be generated are associated with each other, and
the mask generation generates a different mask on a basis of the static information identified from the inputted information, in accordance with the mask generation rule.

5. The receiving node according to any one of claim 2,
wherein the mask generation rule includes information in which information of dynamic information content of which varies while the system is in operation and is hence unidentifiable from the inputted information, and the information of the mask to be generated are associated with each other, and
the mask generation generates a different mask on a basis of the dynamic information, in accordance with the mask generation rule.

6. The receiving node according to claim 5, further comprising mask information storage which stores information of the generated mask,
wherein the mask generation stores, in response to the data storage request, information that allows the mask generated on a basis of the inputted key and time-of-day of the data to be reproduced in the mask information storage, in a case where the mask generation has generated a different mask on a basis of the dynamic information, and
the mask generation generates, in response to the data acquisition request, the mask to be applied to the inputted time-of-day on a basis of the information stored in the mask information storage, in a case where the mask to be generated differs depending on the dynamic information.

7. The receiving node according to any one of claim 1,
wherein the destination-node calculation compares a hash value obtained by inputting the new key generated by the key generation to a predetermined hash function, with a hash value obtained by inputting an identifier of each data server in the predetermined hash function, and determines the data server in which the data is to be stored, by a predetermined allocation method.

8. A data management system comprising:
one or more data servers including data storage which stores data; and
one or more receiving nodes,
wherein each of the receiving nodes includes:
key generation unit which generates a new key using a specified data key and a masked time-of-day acquired by applying a mask to a specified time-of-day; and
destination node calculation unit which identifies the data server in which the data is to be stored, using the new key generated by the key generation unit.

9. A data management method comprising; by a receiving node,
generating a new key using a specified data key and a masked time-of-day acquired by applying a mask to a specified time-of-day, upon receipt of a data storage request or a data acquisition request; and
identifying the data server in which the data is to be stored, using the new key generated by the key generation.

10. A non-transitory computer-readable storage medium storing a data management program configured to cause a computer processing for:
generating a new key using a specified data key and a masked time-of-day acquired by applying a mask to a specified time-of-day, upon receipt of a data storage request or a data acquisition request; and
identifying the data server in which the data is to be stored, using the new key generated in the key generation process.
